(19) United States
(12) Patent Application Publication
(10) Pub. No.: US 2011/0023681 A1
(43) Pub. Date: Feb. 3, 2011

(54) Cutter for styrene board

(75) Inventor: Masahiro Watanabe, Itabasi-ku (JP)

Correspondence Address: JORDAN AND HAMBURG LLP, 122 EAST 42ND STREET, SUITE 4000, NEW YORK, NY, 10168, US

(73) Assignee: Benatechno Co., Ltd., Itabasi-ku (JP)

(21) Appl. No.: 12/311,795

(22) PCT Filed: Oct. 12, 2006
(86) PCT No.: PCT/JP2006/320371

§ 371 Date: Dec. 29, 2009

(51) Int. Cl. B26D 1/03

(52) U.S. Cl. 83/857

(57) ABSTRACT

A cutter for a styrene board has an operation piece and a pair of cutter edges. The operation piece has at its forward end a flat surface coming into surface contact with the upper surface of the styrene board. The pair of cutter edges is attached to the operation piece so as to project in a mountain shape from the forward end of the operation piece. The lower end tip is formed at blades sections of inclined surfaces of the pair of cutter edges, and the tip is used to cut, in substantially a V-shape, that portion of the styrene board which excludes a sheet on the lower surface of the styrene board. Even an unskilled person can finely cut the styrene board in a V-shape, leaving the sheet on the lower surface of the board uncut.

### BACKGROUND OF INVENTION

The present invention relates to cutters for styrene board which are used for making architectural models, the cutters for styrene board being able to cut the styrene board in a substantially V-shape, or in substantially right-angle at an end portion of the same.

A conventional practice to form a prismatic column or the like is done all by hand; in order to cut a styrene board in a substantially V-shape one has to cut the styrene board in substantially 45 degrees at one side, followed by cutting the other side in the same manner so as to cut it out in a substantially triangle shape while carefully leaving a sheet on a lower surface uncut, along which portion the sheet is folded.

Disadvantages of this conventional practice are such that cutting work is not easy and a clean cut is difficult to obtain, as well as that a person unskilled in the art is likely to cut the sheet on the lower surface by mistake or result in an uneven cut surface. In either case the styrene board becomes unusable.

### SUMMARY OF THE INVENTION

In view of the foregoing disadvantages, it is an object of the present invention to provide a cutter for styrene board, with which even a person unskilled in the art can make a clean cut in a V-shape leaving a sheet on a lower surface of a styrene board uncut in an easy operation.

It is further an object of the present invention to provide a cutter for styrene board, with which even a person unskilled in the art can remove an end portion of the styrene board in a clean cut excluding the sheet on the lower surface thereof in an easy operation.

The above and further objects and novel features of the present invention will more fully appear from the following detailed description when the same is read in connection with the accompanying drawings. It is to be understood that these are for purpose of illustration only and are not intended to be a definition of the limits of the invention.

In order to implement the above objective, the present invention comprises a cutter for styrene board further comprising: an operation piece having at its forward end a flat surface which comes into surface contact with an upper surface of the styrene board; and a pair of cutter blades which are attached to the operation piece in such a way that they project in a mountain shape from the forward end thereof, and can cut the styrene board in a substantially V-shape, leaving the sheet on the lower surface of the styrene board uncut, wherein lower forward ends of the cutter blades are formed as cutting edge portions having beveled surfaces.

The present invention comprises the cutter for styrene board further comprising: an operation piece still further comprising a base plate which comes into surface contact with the upper surface of the styrene board, and a cutter blades supporting piece integrally formed with or secured to the base board in such a way that it projects upwardly from the forward end thereof; and a cutter blades attaching piece which is provided with the pair of cutter blades and is detachably attached to the cutter blades supporting piece of the operation piece, wherein the pair of cutter blades have lower forward ends being formed as cutting edge portions, project downwardly in a mountain shape from the base board, and can cut the styrene board in a substantially V-shape, leaving the sheet on the lower surface of the styrene board uncut.

The present invention comprises the cutter for styrene board further comprising: the operation piece still further comprising the base plate which comes into surface contact with the upper surface of the styrene board, and a stand plate which is formed at one end of the base plate in such a way that it projects upwardly therefrom with an angular concave portion in between; and a pair of cutter blades, which are attached to the base plate as well as the stand plate of the operation piece in such a way that they project into the concave portion, their distal ends being located at substantially the same position, wherein the pair of cutter blades cut a portion between the sheet on the lower surface of the styrene board and the expanded polystyrene, as well as the rest portion excluding the sheet on lower surface thereof.

As is clear from the above-mentioned explanations, the present invention as hereinabove defined provides the effects enumerated below.

(1) The present invention comprises an operation piece having at its forward end a flat surface which comes into surface contact with an upper surface of the styrene board, and a pair of cutter blades which are attached to the operation piece in such a way that they project in a mountain shape from the forward end thereof, and can cut the styrene board in a substantially V-shape, leaving the sheet on the lower surface of the styrene board uncut, wherein lower forward ends of the cutter blades are formed as cutting edge portions having beveled surfaces. Therefore the present invention can cut the styrene board in a V-shape leaving the sheet on the lower surface uncut by placing the pair of cutter blades at a desired section to be cut of the styrene board, followed by slide-moving the forward end of the operation piece while being in surface contact with the upper surface thereof. As a result, even a person unskilled in the art can make a clean cut in a V-shape.

(2) According to the above (1), all that is needed is to slide-move the forward end of the operation piece while being in surface contact with the styrene board, so that anyone can cut it in a V-shape easily.

(3) According to the above (1) it has a simple structure and can be produced at low cost.

(4) Claim 2 has the same effect as the above (1) to (3), and because the distal ends of the pair of the cutter blades are disposed offset from each other in an anteroposterior direction, it can provide smooth and clear cutting and reduce resistance to the cutter blades.

(5) Claim 4 can remove the forward end of the styrene board excluding the sheet on the lower surface thereof.

### BRIEF DESCRIPTION OF THE DRAWINGS

FIG. 1 is a front view of a first preferred embodiment of the present invention;

FIG. 2 is a back view of the first preferred embodiment of the present invention;

FIG. 3 is a plan view of the first preferred embodiment of the present invention;

FIG. 4 is a bottom view of the first preferred embodiment of the present invention;

FIG. 5 is a right side view of the first preferred embodiment of the present invention;

FIG. 6 is a left side view of the first preferred embodiment of the present invention;

FIG. 7 is an in-use side view of the first preferred embodiment of the present invention;

FIG. 8 is an in-use front view of the first preferred embodiment of the present invention;

FIG. 9 is a front view of a second embodiment of the present invention;

FIG. 10 is a back view of the second embodiment of the present invention;

FIG. 11 is a right side view of the second embodiment of the present invention;

FIG. 12 is an explanatory drawing of the second embodiment of the present invention with outer members removed therefrom;

FIG. 13 is a front view of a third embodiment of the present invention;

FIG. 14 is a plan view of the third embodiment of the present invention;

FIG. 15 is a right side view of the third embodiment of the present invention;

FIG. 16 is a movement illustration of a cutter blades attaching piece of the third embodiment of the present invention;

FIG. 17 is a front view of a fourth embodiment of the present invention;

FIG. 18 is a plan view of the fourth embodiment of the present invention;

FIG. 19 is a right side view of the fourth embodiment of the present invention;

FIG. 20 is a movement illustration of the cutter blades attaching piece of the fourth embodiment of the present invention;

FIG. 21 is a front view of a fifth embodiment of the present invention;

FIG. 22 is a plan view of the fifth embodiment of the present invention;

FIG. 23 is a right side view of the fifth embodiment of the present invention;

FIG. 24 is an explanatory drawing of the right and left cutter blades attaching piece of the fifth embodiment of the present invention;

FIG. 25 is a front view of a sixth embodiment of the present invention;

FIG. 26 is a plan view of the sixth embodiment of the present invention;

FIG. 27 is a left side view of the sixth embodiment of the present invention; and

FIG. 28 is an in-use explanatory drawing of the sixth embodiment of the present invention.

### DETAILED DESCRIPTION OF THE INVENTION

Preferred embodiments of the present invention will now be described in detail below referring to the accompanying drawings.

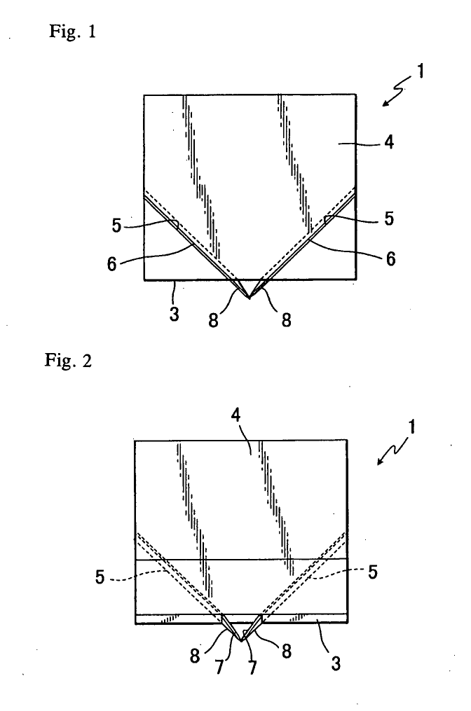

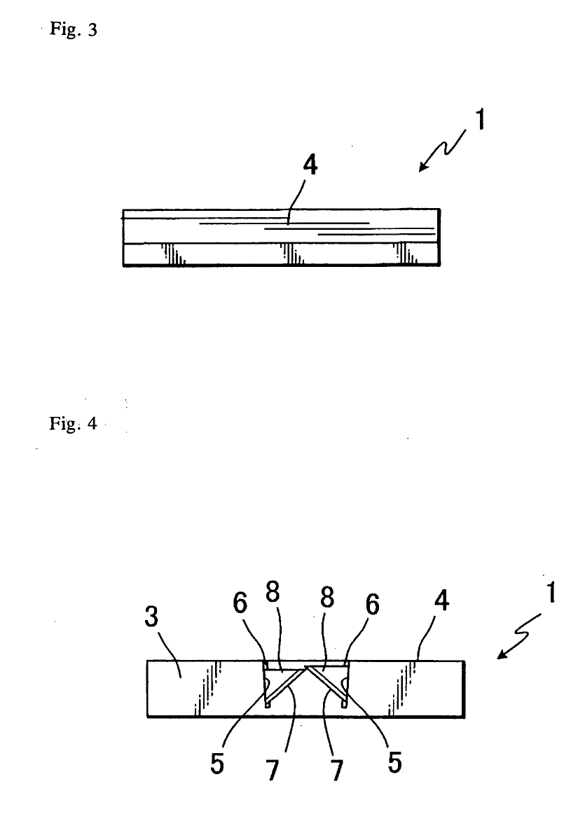

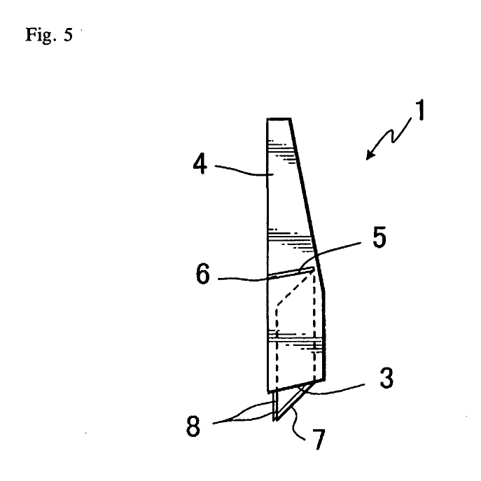

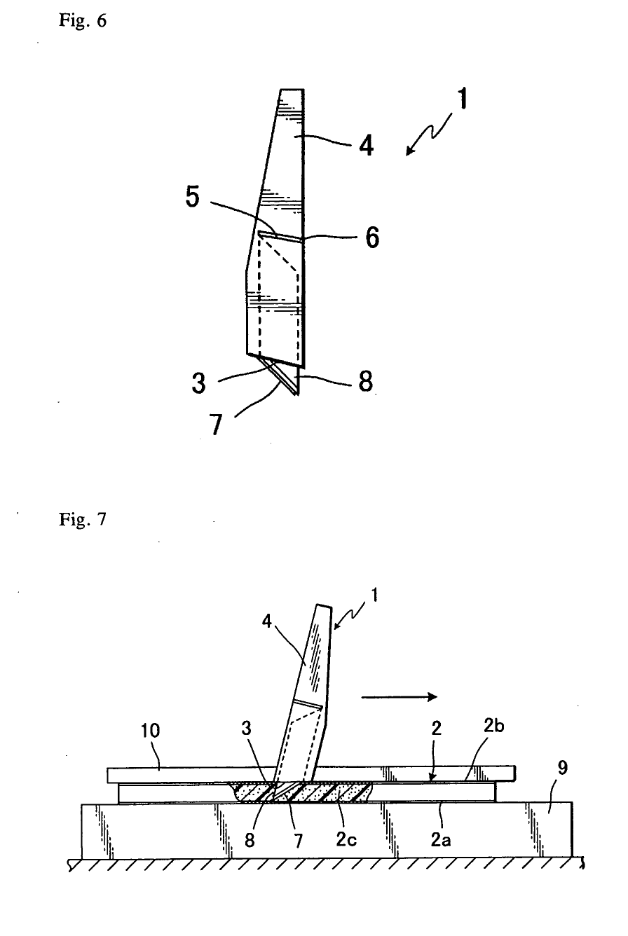

FIGS. 1 to 8 illustrate a first preferred embodiment of the present invention wherein 1 is a cutter for styrene board of the present invention comprising: a substantially rectangular operation piece 4, of which forward end side is thinly shaped, has at its forward end a flat surface 3 which comes into surface contact with an upper surface of the styrene board 2; and a pair of cutter blades 8, 8 of which lower forward ends are formed as cutting edge portions having beveled surfaces, wherein the pair of cutter blades 8, 8 are inserted into cutter blade mounting grooves 5, 5 and are secured therein with filled adhesive 6, and further wherein the pair of cutter blades 8, 8 project in a mountain shape from the forward end of the operation piece 4, and can cut the styrene board 2 in substantially 90 degrees V-shape excluding a sheet on the lower surface 2a, and still further wherein the distal ends of the pair of cutter blades 8, 8 are disposed offset from each other in an anteroposterior direction.

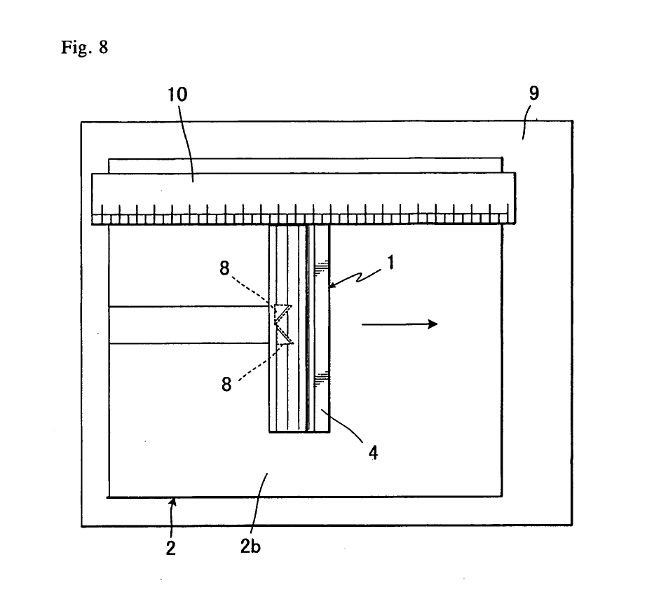

As illustrated in FIGS. 7 and 8, the above constructed cutter for styrene board 1 can cut a sheet on an upper surface 2b of the styrene board and an expanded polystyrene 2c in a V-shape leaving a sheet on the lower surface 2a thereof uncut by the following steps: set the styrene board 2 on a work table 9; set the distal ends of the pair of the cutter blade 8, 8 at outer end portion of the styrene board 2 in such a way that the distal ends are positioned at a center of a portion to be cut in a V-shape; let the forward end of the operation piece 4 come into surface contact with the upper surface of the styrene board 2, while placing a ruler 10 or the like at an end of the operation piece 4 in order to orient an operating direction of the operation piece 4; and slide-move the operation piece 4 along the ruler 10 or the like while keeping the forward end of the operation piece 4 in surface contact with the styrene board 2. When practicing the cutting work as described above, smooth action and clear cutting surface are provided while keeping a portion being cut from being scraped out by the distal ends of the pair of cutter blades 8, 8, thanks to the fact that the lower forward ends of the pair of the cutter blades 8, 8 are beveled surfaces 7, 7, and also the distal ends of the cutter blades 8, 8 are disposed offset from each other in an anteroposterior direction.

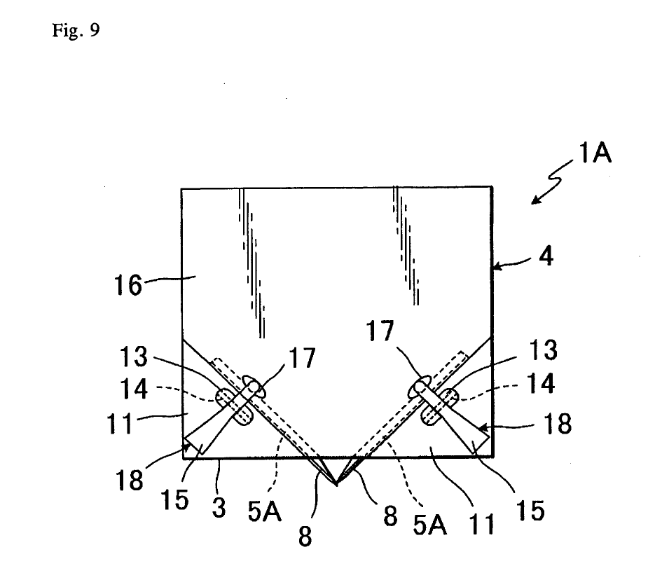

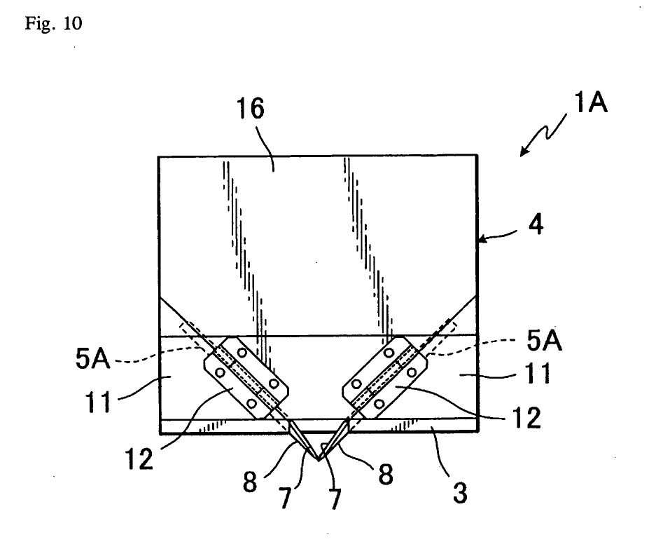

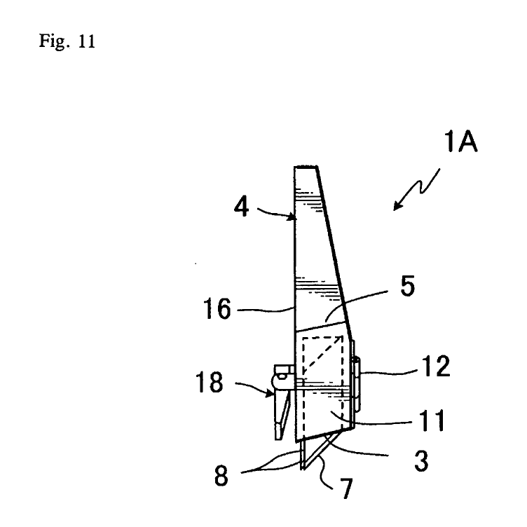

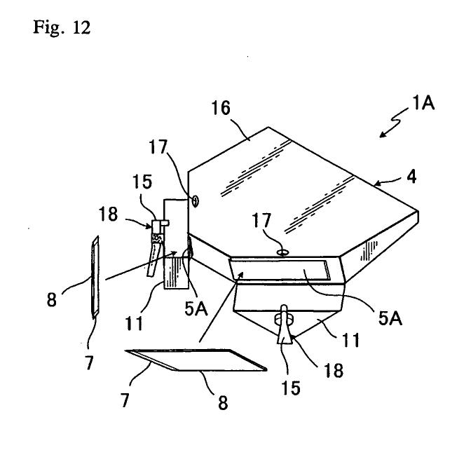

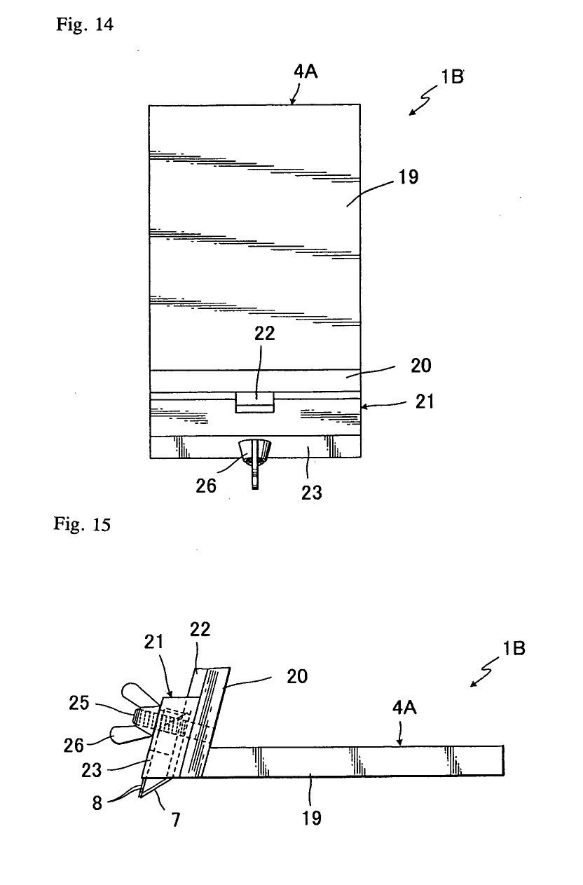

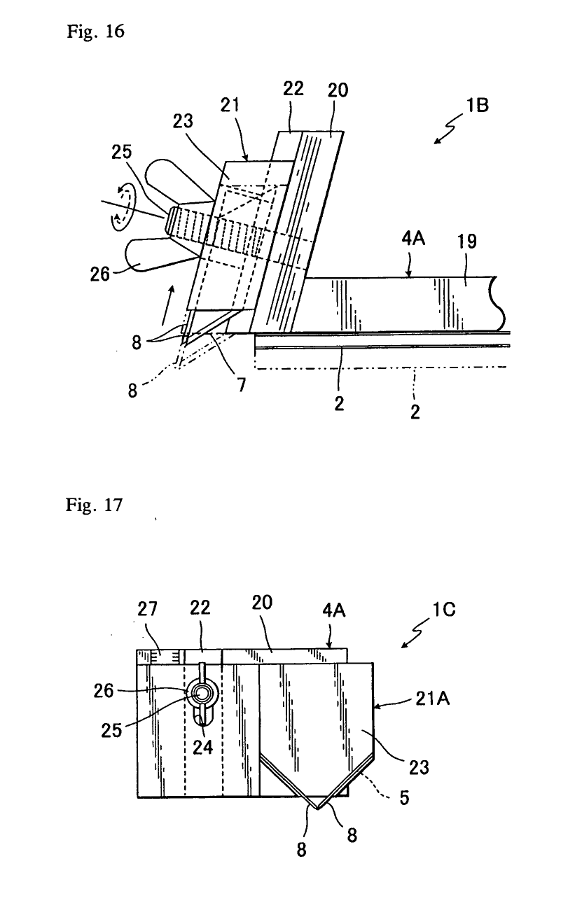

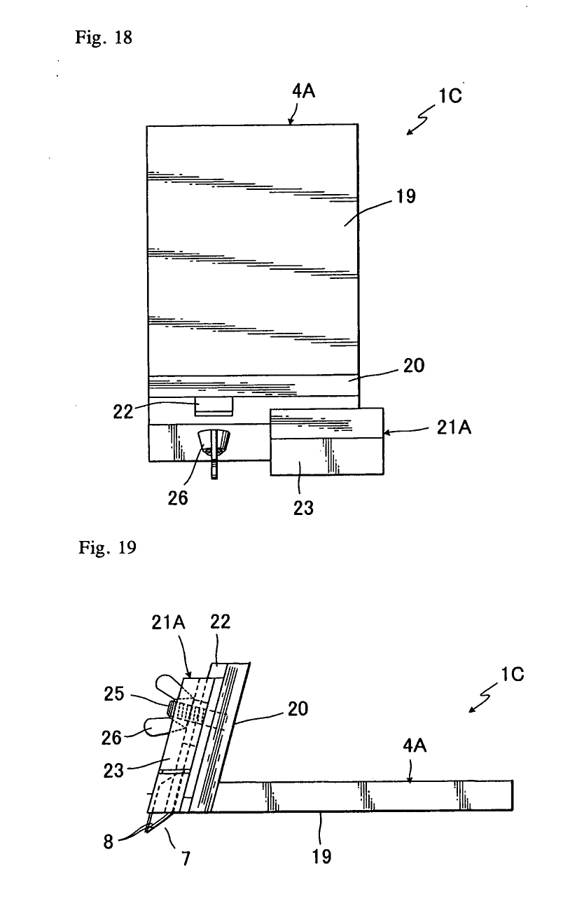

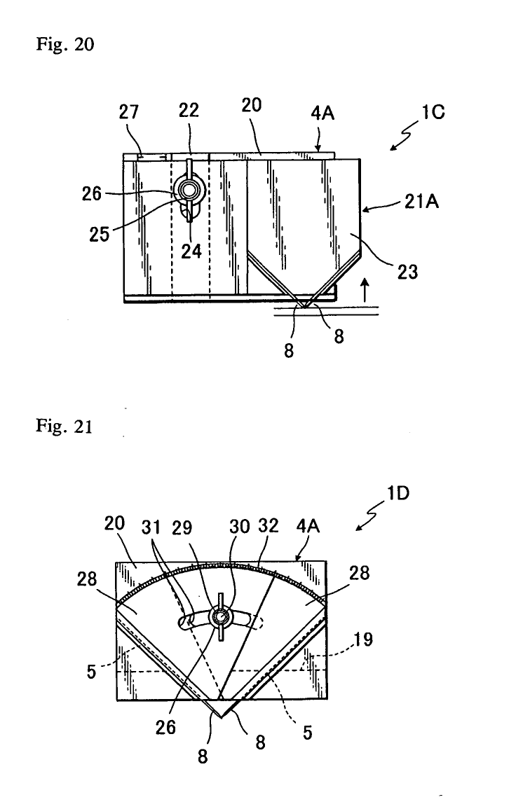

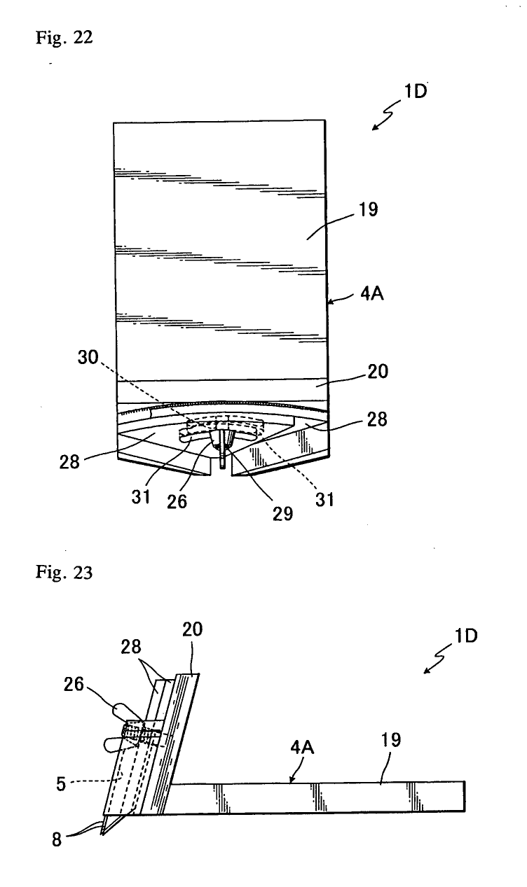

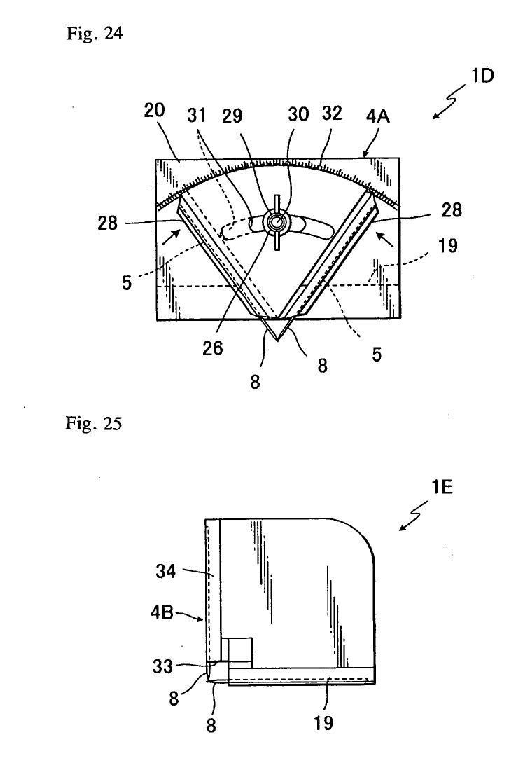

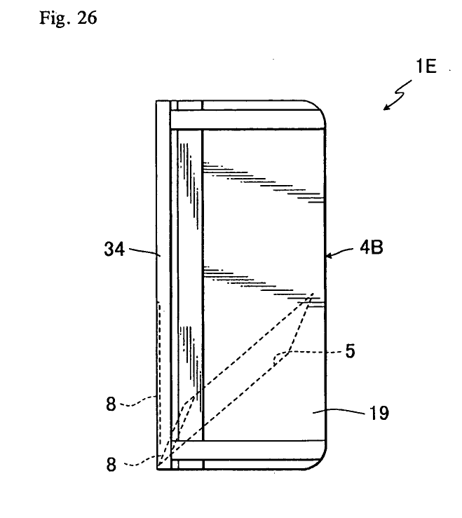

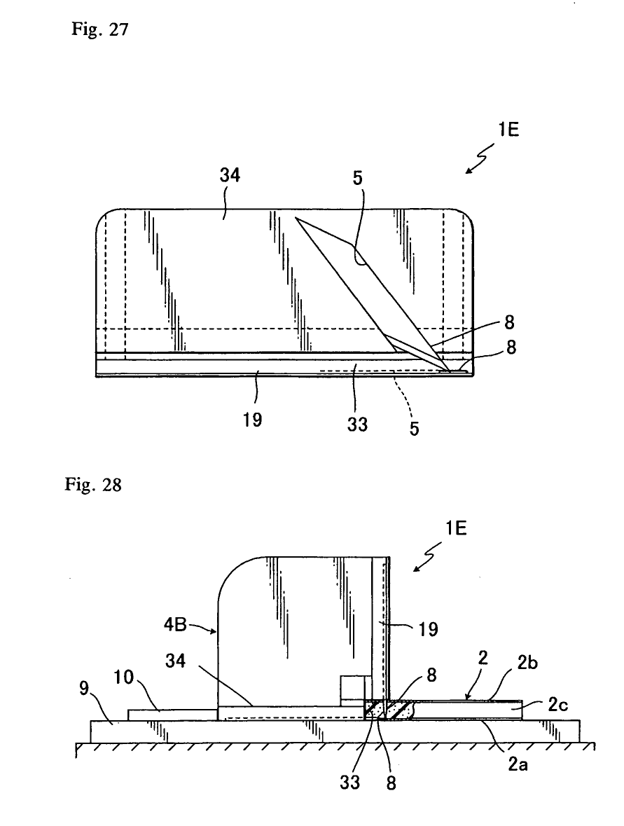

Explained next are other embodiments of the present invention as illustrated in FIGS. 9 to 28. In explaining these other embodiments of the present invention, the same component parts as those in the first preferred embodiment of the present invention are given the same numerals in order to avoid overlapping explanations.

A second embodiment of the present invention is shown in FIGS. 9 to 12 and is distinguished from the first preferred embodiment by the fact that, in order to detachably attach the pair of cutter blades 8, 8 to the operation piece 4, it employs releasable fixtures 18, 18 comprising: levers 15, 15 of which cross-section becomes gradually larger toward its extremity portion, wherein the levers 15, 15 are open/closably attached to outer members 11, 11 disposed at outer portions of cutter blade mounting groove 5A, 5A by using hinge members 12, 12, and further wherein the levers 15, 15 are rotatably attached to pivot members 13, 13 of the outer members 11, 11 by using pivot pins 14, 14; and concave shaped engaging portions 17, 17 formed in an operation piece body 16 and located at inner portions of the outer members 11, 11 to be engaged with the levers 15, 15. A cutter for styrene board 1A composed in this way can provide similar advantages to that according to the first preferred embodiment of the present invention, and also the pair of cutter blades 8, 8 can be replaced with new ones when they have become dull. It is also possible that the releasable fixture 18 is composed in a way the outer members is detachably secured to the operation piece body by using either a bolt, a hook-and-loop fastener, a rubber belt, or an adhesive tape.

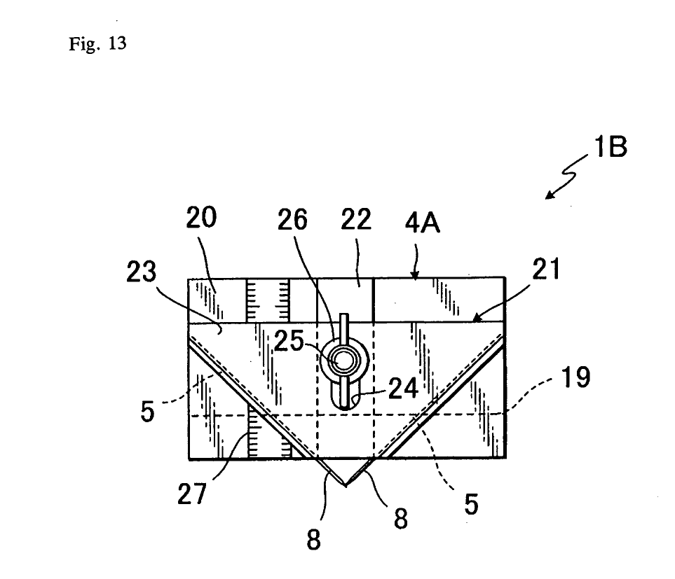

A third embodiment of the present invention is shown in FIGS. 13 to 16 and is distinguished from the first preferred embodiment by the fact that it comprises: an operation piece 4A further comprising a base plate 19 which comes into surface contact with an upper surface of the styrene board 2, and a cutter blades supporting piece 20 integrally formed with or secured to the base board 19 in such a way that it projects back upwardly from its forward end; and a cutter blades attaching piece 21 having the pair of cutter blades 8, 8 which are height-adjustably attached to the cutter blades supporting piece 20 of the operation piece 4A. A cutter for styrene board 1B composed in this way can provide similar advantages to that according to the first preferred embodiment of the present invention, and by adjusting the height, even a styrene board of different thickness can be cut in a V-shape leaving a sheet on the lower surface 2a uncut. The cutter blades attaching piece 21 is further composed of: a substantially triangle cutter blades attaching piece body 23 of which lower corner portions are being cut, wherein the cutter blades attaching piece body 23 is vertically movable guided by a vertically oriented guide piece 22, which is secured at a substantially center of the cutter blades supporting piece 20; vertically oriented elongate hole 24 formed at substantially central portion of the cutter blades attaching piece body 23; a bolt 25 threadably mounted on the guide piece 22 and the cutter blades attaching piece body 23, wherein the bolt 25 projects outwardly from the elongate hole 24; a butterfly nut 26 which is screwed together with the bolt 25 to lock the cutter blades attaching piece body 23 in predetermined position; the pair of cutter blades 8, 8 secured on both sides of the cutter blades attaching piece body 23; and a scale formed on the cutter blades supporting piece 20.

A fourth embodiment of the present invention is shown in FIGS. 17 to 20 and is distinguished from the third embodiment by the fact that a cutter blades attaching piece 21A, to which the pair of cutter blades 8, 8 are attached, is secured to near one end portion of the cutter blades attaching piece 21. A cutter for styrene board 1C composed in this way can provide similar advantages to that according to the third embodiment of the present invention.

A fifth embodiment of the present invention is shown in FIGS. 21 to 24 and is distinguished from the third embodiment by the fact that it employs right and left cutter blades supporting pieces 28, 28 on the cutter blades supporting piece 20 of the operation piece 4A, wherein the cutter blades supporting pieces 28, 28 slidably move from side to side on a circular arc so as to arbitrarily adjust cutting angle of the pair of cutter blades 8, 8, the distal ends thereof serving as a central point. A cutter for styrene board 1D composed in this way can provide similar advantages to that according to the third embodiment of the present invention, and also it can be used by adjusting the cutting angle against the styrene board at between 60 degrees and 120 degrees, for example. The right and left cutter blades attaching piece 28, 28 are slide-movably overlapped with each other except for the outer end portions where the cutter blades 8, 8 are attached thereto, wherein the right and left cutter blades attaching pieces 28, 28 form arc-shaped guide grooves 31, 31 therein to be guided by a pin 30, which forms a thread portion 29 at its tip portion, and is secured at substantially central portion of the cutter blades supporting piece 20. Also, the cutter blades supporting piece 20, which is peripheral of the right and left cutter blades attaching piece 28, 28, marks an angular scale 32 thereon, which indicates a disengaged angle of the right and left cutter blades attaching pieces 28, 28, namely of the pair of cutter blades 8, 8.

A sixth embodiment of the present invention is shown in FIGS. 25 to 28 and is distinguished from the third embodiment by the fact that it comprises: an operation piece 4B further comprising the base plate 19 which comes into surface contact with the upper surface of the styrene board 2 and a stand plate 4B which is formed in such a way that it projects upwardly from one end of the base plate 19, with an angular concave portion 33 in between; and the pair of cutter blades 8, 8 which are attached to the base plate 19 as well as the stand plate 34 of the operation piece 4B in such a way that they project into the concave portion 33, their distal ends being located at substantially the same position, wherein the pair of cutter blades cut a portion between the sheet on the lower surface 2a of the styrene board and the expanded polystyrene 2c, as well as a portion thereof excluding the sheet on the lower surface thereof. A cutter for styrene board 1E composed in this way can provide similar advantages to that according to the first preferred embodiment of the present invention, and also it can be used for cutting an end portion of the styrene board. Each of the embodiments of the present invention explains cases where the stand plate 34 projects upwardly. However, the present invention is not limited to the above embodiments, but may also be a cutter for styrene board which can cut the styrene board in slant planes by forming the stand plate 34 in a slanted way.

The pair of cutter blades for styrene board in each of the embodiments of the present invention may attach covers thereto for protection and safety purposes.

The present invention is applicable in the industry where cutter for styrene board is produced.

1. A cutter for styrene board, the styrene board comprising expanded polystyrene and respective sheets forming upper and lower surfaces of the styrene board, the cutter comprising: an operation piece having at its forward end a flat surface which comes into surface contact with the upper surface of the styrene board; and a pair of cutter blades which are attached to the operation piece in such a way that they project in a mountain shape from the forward end thereof, and can cut the styrene board in a substantially V-shape, leaving the sheet forming the lower surface of the styrene board uncut, wherein lower forward ends of the cutter blades are formed as cutting edge portions having beveled surfaces.

2. The cutter for styrene board, the styrene board comprising expanded polystyrene and respective sheets forming upper and lower surfaces of the styrene board, the cutter comprising: an operation piece comprising a base plate which comes into surface contact with the upper surface of the styrene board, and a cutter blades supporting piece integrally formed with or separately secured to the base plate in such a way that it projects upwardly from a forward end thereof; and a cutter blades attaching piece which is provided with a pair of cutter blades and is detachably attached to the cutter blades supporting piece of the operation piece, wherein the cutter blades have lower forward ends being formed as cutting edge portions, project downwardly in a mountain shape from the base board, and can cut the styrene board in a substantially V-shape, leaving the sheet forming the lower surface of the styrene board uncut.

3. The cutter for styrene board according to claim 1 or 2, wherein the distal ends of the pair of the cutter blades are disposed offset from each other in an anteroposterior direction.

4. The cutter for styrene board, the styrene board comprising expanded polystyrene and respective sheets forming upper and lower surfaces of the styrene board, the cutter comprising: an operation piece comprising a base plate which comes into surface contact with the upper surface of the styrene board, and a stand plate which is formed at one end of the base plate in such a way that it projects upwardly therefrom with an angular concave portion in between; and a pair of cutter blades, which are attached to the base plate as well as the stand plate of the operation piece in such a way that they project into the concave portion, their distal ends being located at substantially the same position, wherein the cutter blades cut a portion between the sheet forming the lower surface of the styrene board and the expanded polystyrene as well as a remaining portion excluding the sheet forming the lower surface thereof.
